(19) United States
(12) Patent Application Publication
(10) Pub. No.: US 2001/0006897 A1
(43) Pub. Date: Jul. 5, 2001

(54) Short message routing apparatus

(75) Inventors: Kyoung Jin Kang, Namyangju (KR); Young Dae Yu, Yongin (KR); Tae Sik Jung, Seoul (KR)

Correspondence Address: FLESHNER & KIM, P.O. Box 221200, Chantilly, VA, 20153-1200, US

(73) Assignee: LG Electronics, Inc.

(21) Appl. No.: 09/750,922

(22) Filed: Jan. 2, 2001

(30) Foreign Application Priority Data
Dec. 30, 1999 (KR) 66097/1999

(51) Int. Cl. H04Q 7/20

(52) U.S. Cl. 455/466; 455/433; 455/461

(57) ABSTRACT

A short message routing apparatus of a short message transmitting device is disclosed, in which a mobile originated short message is transmitted through a base station, a switching system and a short message system center (SMSC) to a subscriber. The system includes a short message routing control system (SMRS) having a prefix configuration file for routing a short message between the switching system and the SMSC.

### BACKGROUND OF THE INVENTION

1. Field of the Invention

The present invention relates to a mobile communication system, and more particularly, to a short message routing apparatus in a mobile communication system

2. Background of the Related Art

FIG. 1 is a schematic block diagram of a related art short message transmitting device. As shown in FIG. 1, the related art short message transmitting device includes a plurality of base transceiver systems (BTS) 20˜20n for receiving short messages from mobile communication subscribers and performing transmitting/receiving functions and communication protocol converting functions of radio signals for corresponding mobile terminals 10˜10n. The device further includes plurality of base station controllers 30˜30n for performing functions of BTS control, radio resource management, and soft/hard hand-over. Next, a mobile switching center 40 (MSC) is provided to route the short messages received form the BSCs 30˜30n through a No. 7 signaling network, and a plurality of short message system centers (SMSC) 50˜50n are provided to receive the short messages from the MSC 40 through the SS7 (Signaling System 7) network and output the messages to corresponding subscribers through an ethernet.

The MSC 40 includes a destination prefix and a prefix configuration file 40-1 that stores a point code table of the SMSC (50˜50n) for the destination prefix.

The ethernet is connected with an information provider (IP) 60, an external short message entity (ESME) 70, and an Internet user 80. Reference numeral 90 denotes a home location register (HLR) which is coupled to the SS7 and stores subscriber position information.

The operation of the related art apparatus for transmitting a short message will now be described. First, a short message generated from mobile terminal (10˜10n) subscribers is transmitted through the BTS (20˜20n) and the BSC (30˜30n) to the MSC (40). Then, the MSC 40 transmits a corresponding short message to the SMSC (50˜50n) using the destination prefix of the short message and the point code table of the SMSC in accordance with the prefix configuration file 40-1. That is, the MSC 40 checks the destination prefix of the short message and the point code of the SMSC, and transmits the short message to the SMSC (50˜50n) corresponding to the prefix.

At this time, the MSC 40 identifies position information of the subscriber from the HLR 90. Accordingly, the SMSC 50˜50n transmits the received short message through the ethernet to the IP 60, to the ESME 70 or to the Internet user 80.

As the number of mobile communication subscribers continuously increases, voice mail notification, melody download, e-mail, various information services (i.e., whether, stocks, traffic, news reports, etc.), and short messages are increasingly used. Thus, the SMSC is increasingly installed and user prefixes are frequently changed.

The related art short message transmitting apparatus, however, has various problems. For example, the prefix configuration file is provided in the MSC. Thus, whenever the prefixes are changed or whenever a message receipt is changed by the MSC, an operator must change the destination prefix of the short message and correct the point code table of the SMSC in every MSC. This takes considerable time and results in a large expense being incurred.

In addition, for a system that is regularly operated, the correcting operation of the short message and the point code table of the SMSC is typically performed at night time which is disadvantageous.

The above references are incorporated by reference herein where appropriate for appropriate teachings of additional or alternative details, features and/or technical background.

### SUMMARY OF THE INVENTION

An object of the present invention is to provide a short message routing apparatus that substantially obviates problems caused by disadvantages of the related art.

Another object of the present invention is to provide a short message routing apparatus which can easily change a destination prefix of a short message and easily corrects the point code table.

Another object of the present invention is to provide a short message routing apparatus which implements a prefix configuration file in a separate short message routing control system.

To achieve at least these objects in whole or in parts, there is provided a short message routing apparatus of a short message transmitting device in which a short message generated from a mobile terminal is transmitted through a base transceiver system (BTS), a mobile switching center (SC) and a short message system center (SMSC) to a subscriber, including a routing control system (SMRS) for routing a short message in consideration of a destination prefix configuration file included in the SMRS.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic block diagram of a related art short message transmitting device; and

FIG. 2 is a schematic block diagram of a short message routing apparatus in accordance with the preferred embodiment of the present invention.

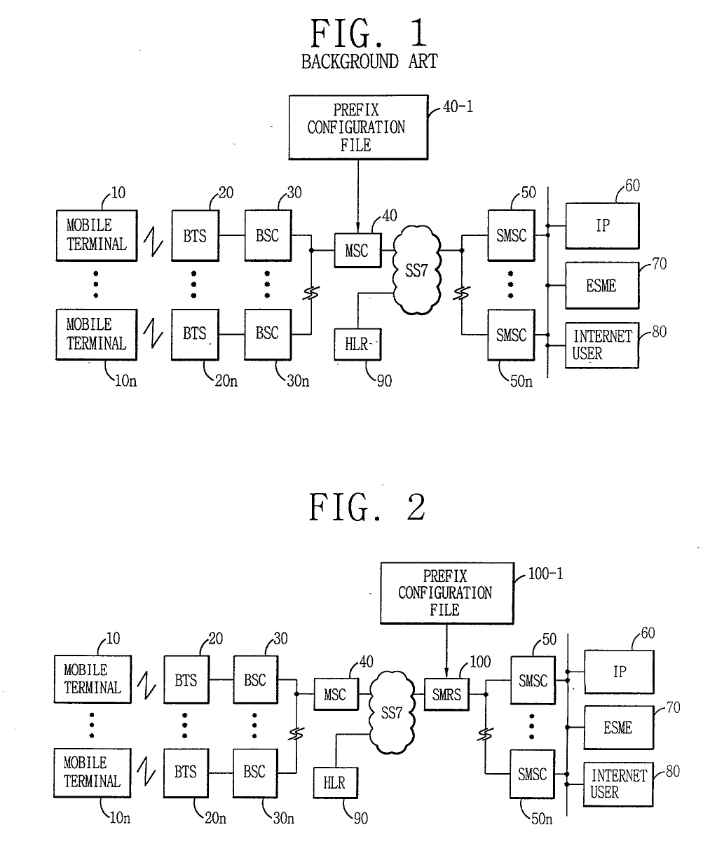

### DETAILED DESCRIPTION OF PREFERRED EMBODIMENTS

Referring to FIG. 2, the short message routing apparatus of the preferred embodiment preferably includes a plurality of base station transceiver systems (BTS) 20˜20n, configured to receive short messages from mobile communication subscribers using a plurality of mobile terminals 10˜10n. The system also preferably includes a plurality of base station controllers 30˜30n to control the operation of the BTS 20˜20n. Each of the plurality of BSCs 30˜30n is coupled to a mobile switching center 40 (MSC), which is coupled to a SS7 network. A home location register (HLR) is also provided, and is coupled to the SS7 network.

The system also includes a short message routing control system (SMRS) 100 coupled to the SS7 network, and to which a plurality of short message system centers (SMSC) 50˜50n are coupled. The SMRS 100 includes a prefix configuration file 100-1 which stores a destination prefix of a short message and a point code table of the SMSC 50˜50n for the destination prefix.

An operation of the preferred embodiment of the short message routing apparatus will next be described with reference to FIG. 2.

A short message generated from a subscriber of mobile terminals (10˜10n) is first transmitted through the BTS 20 and the BSC 30 to the MSC 40. Then, the MSC 40 transmits every short message, as received, through the SS7 network to the point code of the SMRS 100.

The SMRS 100 identifies the prefix of the prefix configuration file 100-1 and the point code, and transmits the short messages to the SMSC (50˜50n) which corresponds to the prefix. Accordingly, the SMSC 50 processes the received short message by prefixes and transmits it through a network, for example an ethernet, to a corresponding subscriber, for example, to an IP 60, an ESME 70, a different mobile terminal, or an Internet user 80.

Accordingly, when the message receipt is changed or the prefix is changed in the SMSC, the operator does not need to correct or change the prefixes of a system operating center of every area, nor does the operator need to correct the point code table. Instead, the operator only needs to correct and change the corresponding prefix and the point code information in the prefix configuration file 100-1 of the SMRS 100. The operator can thus easily change the prefix and the message receipt of the SMSC even in a regularly operated system.

The short message routing apparatus of the preferred embodiment separately includes the short message routing control signal (SMRS) 100 having the prefix configuration file 100-1 between the mobile switching center (MSC) and the SMSC.

Accordingly, the SMRS can be favorably adopted to mobile communication service providers having many of mobile communication subscribers because the operator can easily correct and change a prefix and a point code table in the operating system. In addition, the time and expense for changing the prefix and the message demands of the SMSC can be reduced compared to that of the conventional art. Moreover, the inconveniences of the related art can be thus removed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A short message routing apparatus of a short message transmitting device, comprising:
a switching system;
a short message system center (SMSC); and
a short message routing control system (SMRS), wherein the SMRS is configured to route a short message between the switching system and the SMSC.

2. The apparatus of claim 1, wherein the SMRS comprises a prefix configuration file, which stores a destination prefix of the short message and a point code table of the SMSC for the destination prefix.

3. A short message routing apparatus, comprising:
a short message routing control system (SMRS); and
a prefix configuration file, wherein the SMRS is configured to couple a switching system to at least one short message system center (SMSC).

4. The apparatus of claim 3, wherein the switching system comprises a No. 7 signaling network.

5. The apparatus of claim 4, further comprising a mobile switching center (MSC) coupled to the No. 7 signaling network, wherein the MSC is configured to receive at least one short message from at least one base station controller.

6. The apparatus of claim 5, further comprising a home location register coupled to the No. 7 signaling network.

7. The apparatus of claim 3, wherein the SMRS receives a short message from the switching system, and provides the short message to a corresponding SMSC according to addressing information in the short message.

8. The apparatus of claim 7, wherein the addressing information comprises a destination prefix.

9. The apparatus of claim 8, wherein the prefix configuration file comprises a point code table of the SMSC, wherein the SMRS stores a destination prefix of the short message and processes the short message using the destination prefix and the point code table to determine a destination.

10. The apparatus of claim 3, wherein the prefix configuration file stores a point code table of the at least one SMSC.

11. The apparatus of claim 3, wherein the SMRS is connected between the switching system and the SMSC.

12. A method of routing a short message in a network, comprising:
receiving a short message having a destination prefix from a switching network;
identifying the prefix of the short message;
identifying a corresponding point code for the prefix in a prefix configuration file;
transmitting the short message to a short message system center corresponding to the prefix.

13. The method of claim 12, wherein the switching network is a No. 7 signaling network.

14. The method of claim 12, wherein the short message system center processes the received short message by the prefix and transmits it to a corresponding subscriber.

15. A short message routing apparatus, comprising:
a plurality of mobile terminals, each configured to transmit a short message;
a plurality of base station transceiver systems coupled to receive the short messages from each of the plurality of mobile terminals;
a plurality of base station controllers, configured to control the base station transceivers and receive the short message;
a mobile switching center, coupled to receive the short message from each of the plurality of base station controllers;
a home location register configured to store position information of a plurality of subscribers;
a No. 7 signaling network coupled to the mobile switching center and the home location register to receive the short messages and addressing information;
a short message routing control system (SMRS) coupled to the No. 7 signaling network to receive the short messages and identify a destination prefix of each of the short messages;
a prefix configuration file, configured to store a point code table and to process the destination prefix of the short message and identify a point code; and
a plurality of short message system centers, each having a unique point code, and each coupled to receive short messages corresponding to the point code.
